(19) United States
(12) Patent Application Publication
(10) Pub. No.: US 2024/0419518 A1
(43) Pub. Date: Dec. 19, 2024

(54) AUTONOMOUSLY REGULATING MESSAGES INTO TARGET APPLICATIONS

(71) Applicant: International Business Machines Corporation, Armonk, NY (US)

(72) Inventors: Arunava Majumdar, CHICAGO, IL (US); Monjita Sharma, Bangalore (IN); Jeff McNeely, Princeton, TX (US); Laura Smith, Dallas, TX (US)

(21) Appl. No.: 18/210,468

(22) Filed: Jun. 15, 2023

(51) Int. Cl. G06F 9/54; G06F 11/34

(52) U.S. Cl. CPC G06F 9/546; G06F 11/3409

(57) ABSTRACT

An example operation may include one or more of sending messages from a host system to one or more target systems at a constant rate, wherein the processor is configured to load the messages from one or more source systems, determining that a performance of the host system, network or other system parameters has changed, maintaining the constant rate of messages from the host system to the one or more target systems based on the determination, and dynamically modifying one or more loading threads of the host system to maintain the constant rate.

### BACKGROUND

Testing tools can be used to measure the performance of a software application when being executed in a network environment. These tools may simulate users interacting with the software application, record the behavior of the software application when interacting with the simulated users, and analyze the results.

### SUMMARY

One example embodiment provides an apparatus that includes a processor that may send messages from a host system to one or more target systems at a constant rate, wherein the processor is configured to load the messages from one or more source systems, determine that a performance of the host system, network or other system parameters has changed, maintain the constant rate of messages from the host system to the one or more target systems based on the determination, and dynamically modify one or more loading threads of the host system to maintain the constant rate.

Another example embodiment provides a method that includes one or more of sending messages from a host system to one or more target systems at a constant rate, wherein the processor is configured to load the messages from one or more source systems, determining that a performance of the host system, network or other system parameters has changed, maintaining the constant rate of messages from the host system to the one or more target systems based on the determination, and dynamically modifying one or more loading threads of the host system to maintain the constant rate.

A further example embodiment provides a computer-readable medium comprising instructions, that when read by a processor, cause the processor to perform one or more of sending messages from a host system to one or more target systems at a constant rate, wherein the processor is configured to load the messages from one or more source systems, determining that a performance of the host system, network or other system parameters has changed, maintaining the constant rate of messages from the host system to the one or more target systems based on the determination, and dynamically modifying one or more loading threads of the host system to maintain the constant rate.

### BRIEF DESCRIPTION OF THE DRAWINGS

FIG. 1 depicts a computing environment, according to example embodiments.

FIG. 2A is a diagram illustrating a host system for delivering a constant rate of messages to a target system according to example embodiments.

FIGS. 2B-2D are diagrams illustrating processes performed by the host system of FIG. 2A for delivering a constant rate of messages according to example embodiments.

FIG. 2E is a diagram illustrating a process of autonomously regulating a flow of messages from a source to a target according to example embodiments.

FIG. 3A is a diagram illustrating a method of regulating a flow of messages into a target system according to example embodiments.

FIG. 3B is a diagram illustrating a method of regulating a flow of messages into a target application according to other example embodiments.

FIG. 3C is a diagram illustrating a method of regulating a flow of messages into a target application according to further example embodiments.

### DETAILED DESCRIPTION

It is to be understood that although this disclosure includes a detailed description of cloud computing, implementation of the teachings recited herein is not limited to a cloud computing environment. Rather, embodiments of the instant solution are capable of being implemented in conjunction with any other type of computing environment now known or later developed.

Simple test scenarios for delivering messages at a constant rate may be performed by queuing messages at a predefined intermittent rate of seconds or milliseconds before directing a next message. However, this process does not guarantee the message rate at any given time nor is it regulated in a particular manner because system performance and other factors can change. The ramp-up time for these messages to be sent at the rate specified is not monitored and can only be approximated. When running a test for a long period of time there may be other CPU-bound or IO-bound activities on the system that may slow down the rate and may not be autonomously adjusted.

The example embodiments are directed to a system that can ensure a constant rate of messages to a target application, especially in situations where system performance changes due to external factors such as CPU-bound and IO-bound activities. The target application may need a constant rate of messages/data for various reasons, for example, to test the performance of the target application, and the like. For example, the target application may be required to process messages at fifty messages/per second. In this experiment, the test will fail if the test system cannot provide a message rate of at least fifty messages per second to the target application. It should be appreciated that the autonomous regulation system described herein may be used to regulate a message flow of data in many different environments, including a cloud environment, and from many types of source systems to many types of destination systems.

To ensure a constant rate of flow, the system described herein separates loading logic and output logic for sending messages. In one example, a cache, queue, or the like, is embodied between the loading logic and the output logic to help ensure that the output rate of messages to the target application remains constant. In this example, the cache may store a buffer of messages that have been loaded by the loading threads which are waiting to be sent to a target application by the sending threads. The sending threads may take messages out of the queue and submit them to the target application. In one embodiment, the loading threads logic for loading data to the intermediate first-in-first-out (FIFO) storage is independent of the logic for sending data from the storage, and the sending threads logic for sending data from the storage is independent of the logic for loading data into the storage.

According to various embodiments, the host system described herein can modify the loading, the sending, or both, to ensure that messages are being delivered at a constant rate (or near constant rate) to the target application. Here, the host system may include monitors which monitor the performance of the loading thread(s) and the sending thread(s). The monitors can also trigger additional threads to be added in the event one or both threads need to ensure the constant rate to the target application. In some embodiments, the host system described herein may be referred to as an “autonomous” system because the regulation is performed, at the time, without any other intervention. The system reacts to changes in performance such as slowdowns in loading and/or sending, and autonomously reacts/updates aspects of the system to ensure that the constant rate of messages to the target system is maintained.

By bifurcating the logic, the system can independently control the loading rate with respect to the sending rate. For example, the system can spawn an additional loading thread (or threads) independent of the number of sending threads, based on the rate at which loading into the storage is taking place and the number of messages in the store. If the storage is full or the rate at which the loading into the storage increases, the additional loading threads are decreased until none exist other than the primary loading thread which continues to load data until the storage limit is reached and can then pause. Furthermore, if the primary sending thread fails to send data at the constant rate and falls below the rate, an additional sender thread (or threads) may be spawned, independent of an activity associated with the loading thread, to send more data to the destination. The pause between the consecutive sending of data can be readjusted based on the constant rate requirements. If the sender response improves and the rate is calculated to be able to handle with a lesser number of secondary sender threads, the system may reduce the number of threads to optimize performance of the system, until only the primary sender thread remains active.

Some of the benefits of the example embodiments include the separation of logic into loading and sending of data, abstraction of loaders and senders as data sources, read forward, caching and cache monitoring, autonomously regulating time intervals in nanoseconds, adjustable tolerance values to regulate fluctuations due to input-output (IO) activities, cumulative monitoring of message output and adjusting values autonomously, load regulation by spawning and de-spawning of secondary loader threads, send regulation by spawning and de-spawning of secondary sender threads, autonomously regulating all parameters for the specified duration of task, reporting all statistical results at the end of the test, option to complete the task even if the regulation falls below the tolerance value, and the like.

The abstraction of the loaders and the senders can be performed within the code itself. By calling the interfaces in the code, they are abstracted and may be extended into any specific source and target protocols for retrieving and sending data, respectively. The data may be received in any format and the system considers it as a binary input and output without interfering with the data. If the system receives data in a consistent manner through the interface, the process will continue to run. If the system detects a change in performance of some kind, the system can adjust aspects of the loading and/or the sending sides of the system to ensure a desired constant rate of delivery to the target application. The data may be sent into the system from a single or multiple sources and the data may be sent to a single or multiple targets based on the configuration. The constant data rate may be maintained for a single target of a set of targets based on the configuration. Regardless, the host system described herein can regulate the flow of messages from more than one system into a target application at the constant rate desired by the target application.

Cloud computing is a model of service delivery for enabling convenient, on-demand network access to a shared pool of configurable computing resources (e.g., networks, network bandwidth, servers, processing, memory, storage, applications, virtual machines, and services) that can be rapidly provisioned and released with minimal management effort or interaction with a provider of the service. This cloud model may include at least five characteristics, at least three service models, and at least four deployment models.

Characteristics are as follows:

On-demand self-service: a cloud consumer can unilaterally provision computing capabilities, such as server time and network storage, as needed automatically without requiring human interaction with the service's provider.

Broad network access: capabilities are available over a network and accessed through standard mechanisms that promote use by heterogeneous thin or thick client platforms (e.g., mobile phones, laptops, and PDAs).

Resource pooling: the provider's computing resources are pooled to serve multiple consumers using a multi-tenant model, with different physical and virtual resources dynamically assigned and reassigned according to demand. There is a sense of location independence in that the consumer generally has no control or knowledge over the exact location of the provided resources but may be able to specify location at a higher level of abstraction (e.g., country, state, or data center).

Rapid elasticity: capabilities can be rapidly and elastically provisioned, in some cases automatically, to quickly scale out and rapidly released to quickly scale in. To the consumer, the capabilities available for provisioning often appear to be unlimited and can be purchased in any quantity at any time.

Measured service: cloud systems automatically control and optimize resource use by leveraging a metering capability at some level of abstraction appropriate to the type of service (e.g., storage, processing, bandwidth, and active user accounts). Resource usage can be monitored, controlled, and reported, providing transparency for both the provider and consumer of the utilized service.

Service Models are as follows:

Software as a Service (SaaS): the capability provided to the consumer is to use the provider's applications running on a cloud infrastructure. The applications are accessible from various client devices through a thin client interface such as a web browser (e.g., web-based e-mail). The consumer does not manage or control the underlying cloud infrastructure, including network, servers, operating systems, storage, or even individual application capabilities, with the possible exception of limited user-specific application configuration settings.

Platform as a Service (PaaS): the capability provided to the consumer is to deploy onto the cloud infrastructure consumer-created or acquired applications created using programming languages and tools supported by the provider. The consumer does not manage or control the underlying cloud infrastructure, including networks, servers, operating systems, or storage, but has control over the deployed applications and possibly application hosting environment configurations.

Infrastructure as a Service (IaaS): the capability provided to the consumer is to provision processing, storage, networks, and other fundamental computing resources where the consumer is able to deploy and run arbitrary software, which can include operating systems and applications. The consumer does not manage or control the underlying cloud infrastructure but has control over operating systems, storage, deployed applications, and possibly limited control of select networking components (e.g., host firewalls).

Deployment Models are as follows:

Private cloud: the cloud infrastructure is operated solely for an organization. It may be managed by the organization or a third party and may exist on-premises or off-premises.

Community cloud: the cloud infrastructure is shared by several organizations and supports a specific community with shared concerns (e.g., mission, security requirements, policy, and compliance considerations). It may be managed by organizations or a third party and may exist on-premises or off-premises.

Public cloud: the cloud infrastructure is made available to the general public or a large industry group and is owned by an organization selling cloud services.

Hybrid cloud: the cloud infrastructure is a composition of two or more clouds (private, community, or public) that remain unique entities but are bound together by standardized or proprietary technology that enables data and application portability (e.g., cloud bursting for load-balancing between clouds).

A cloud computing environment is service-oriented with a focus on statelessness, low coupling, modularity, and semantic interoperability. At the heart of cloud computing is an infrastructure that includes a network of interconnected nodes.

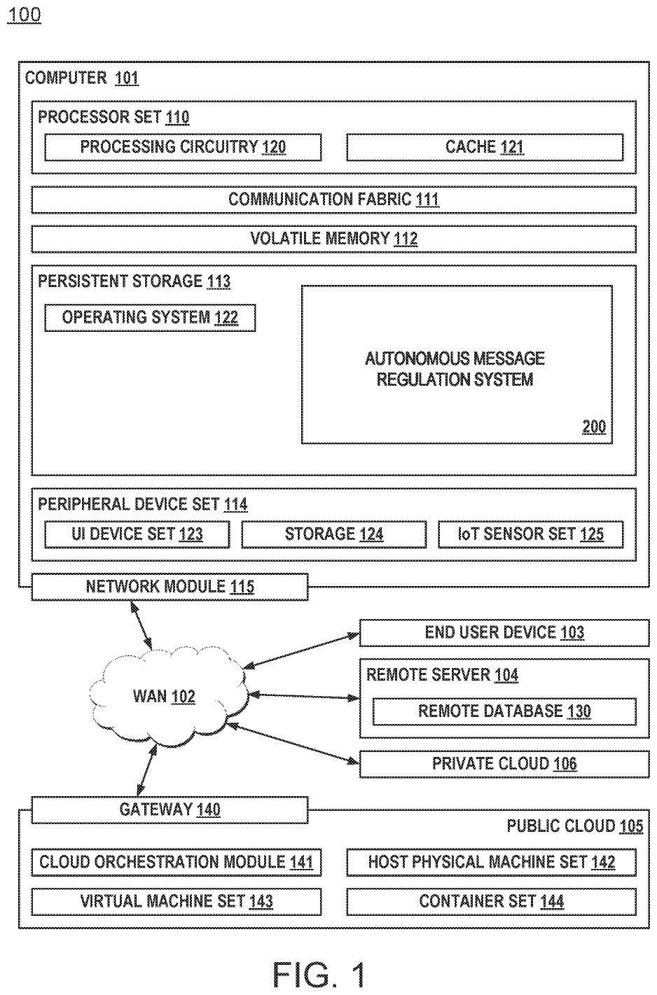

Referring now to FIG. 1, a computing environment 100 is depicted. Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again, depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

Computing environment 100 contains an example of an environment for executing at least some of the computer code involved in performing the inventive methods, such as autonomous message regulation system 200. In addition to block 200, computing environment 100 includes, for example, computer 101, wide area network (WAN) 102, end-user device (EUD) 103, remote server 104, public cloud 105, and private cloud 106. In this embodiment, computer 101 includes processor set 110 (including processing circuitry 120 and cache 121), communication fabric 111, volatile memory 112, persistent storage 113 (including operating system 122 and block 200, as identified above), peripheral device set 114 (including user interface (UI), device set 123, storage 124, and Internet of Things (IoT) sensor set 125), and network module 115. Remote server 104 includes remote database 130. Public cloud 105 includes gateway 140, cloud orchestration module 141, host physical machine set 142, virtual machine set 143, and container set 144.

COMPUTER 101 may take the form of a desktop computer, laptop computer, tablet computer, smartphone, smartwatch or other wearable computer, mainframe computer, quantum computer or any other form of computer or mobile device now known or to be developed in the future that is capable of running a program, accessing a network or querying a database, such as remote database 130. The performance of a computer-implemented method may be distributed among multiple computers and/or between multiple locations. In this presentation of the computing environment 100, a detailed discussion is focused on a single computer, specifically computer 101, to keep the presentation as simple as possible. Computer 101 may be located in a cloud, even though it is not depicted in a cloud in FIG. 1.

PROCESSOR SET 110 includes one, or more, computer processors of any type now known or to be developed in the future. Processing circuitry 120 may be distributed over multiple packages, for example, multiple, coordinated integrated circuit chips. Processing circuitry 120 may implement multiple processor threads and/or multiple processor cores. Cache 121 is a memory that is located in the processor chip package(s) and is typically used for data or code that should be available for rapid access by the threads or cores running on processor set 110. Cache memories are typically organized into multiple levels depending upon relative proximity to the processing circuitry. Alternatively, some, or all, of the cache for the processor set may be located “off-chip.” In some computing environments, processor set 110 may be designed for working with qubits and performing quantum computing.

Computer readable program instructions are typically loaded onto computer 101 to cause a series of operational steps to be performed by processor set 110 of computer 101 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 121 and the other storage media discussed below. The program instructions, and associated data, are accessed by processor set 110 to control and direct performance of the inventive methods. In computing environment 100, at least some of the instructions for performing the inventive methods may be stored in block 200 in persistent storage 113.

COMMUNICATION FABRIC 111 is the signal conduction path that allows the various components of computer 101 to communicate with each other. Typically, this fabric comprises switches and electrically conductive paths, such as the switches and electrically conductive paths that make up buses, bridges, physical input/output ports, and the like. Other types of signal communication paths may be used, such as fiber optic communication paths and/or wireless communication paths.

VOLATILE MEMORY 112 is any type of volatile memory now known or to be developed in the future. Examples include dynamic type random access memory (RAM) or static type RAM. Typically, the volatile memory is characterized by random access, but this is not required unless affirmatively indicated. In computer 101, the volatile memory 112 is located in a single package and is internal to computer 101, but, alternatively or additionally, the volatile memory may be distributed over multiple packages and/or located externally with respect to computer 101.

PERSISTENT STORAGE 113 is any form of non-volatile storage for computers that is now known or to be developed in the future. The non-volatility of this storage means that the stored data is maintained regardless of whether power is being supplied to computer 101 and/or directly to persistent storage 113. Persistent storage 113 may be a read-only memory (ROM), but typically at least a portion of the persistent storage allows writing of data, deletion of data, and re-writing of data. Some familiar forms of persistent storage include magnetic disks and solid-state storage devices. Operating system 122 may take several forms, such as various known proprietary operating systems or open source Portable Operating System Interface type operating systems that employ a kernel. The code included in block 200 typically includes at least some of the computer code involved in performing the inventive methods.

PERIPHERAL DEVICE SET 114 includes the set of peripheral devices of computer 101. Data communication connections between the peripheral devices and the other components of computer 101 may be implemented in various ways, such as Bluetooth connections, Near-Field Communication (NFC) connections, connections made by cables (such as universal serial bus (USB) type cables), insertion type connections (for example, secure digital (SD) card), connections made through local area communication networks and even connections made through wide area networks such as the internet. In various embodiments, UI device set 123 may include components such as a display screen, speaker, microphone, wearable devices (such as goggles and smartwatches), keyboard, mouse, printer, touchpad, game controllers, and haptic devices. Storage 124 is external storage, such as an external hard drive, or insertable storage, such as an SD card. Storage 124 may be persistent and/or volatile. In some embodiments, storage 124 may take the form of a quantum computing storage device for storing data in the form of qubits. In embodiments where computer 101 is required to have a large amount of storage (for example, where computer 101 locally stores and manages a large database) then this storage may be provided by peripheral storage devices designed for storing very large amounts of data, such as a storage area network (SAN) that is shared by multiple, geographically distributed computers. IoT sensor set 125 is made up of sensors that can be used in Internet of Things applications. For example, one sensor may be a thermometer, and another sensor may be a motion detector.

NETWORK MODULE 115 is the collection of computer software, hardware, and firmware that allows computer 101 to communicate with other computers through WAN 102. Network module 115 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 115 are performed on the same physical hardware device. In other embodiments (for example, embodiments that utilize software-defined networking (SDN)), the control functions and the forwarding functions of network module 115 are performed on physically separate devices, such that the control functions manage several different network hardware devices. Computer readable program instructions for performing the inventive methods can typically be downloaded to computer 101 from an external computer or external storage device through a network adapter card or network interface included in network module 115.

WAN 102 is any wide area network (for example, the internet) capable of communicating computer data over non-local distances by any technology for communicating computer data now known or to be developed in the future. In some embodiments, the WAN may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers, and edge servers.

END USER DEVICE (EUD) 103 is any computer system that is used and controlled by an end user (for example, a customer of an enterprise that operates computer 101) and may take any of the forms discussed above in connection with computer 101. EUD 103 typically receives helpful and useful data from the operations of computer 101. For example, in a hypothetical case where computer 101 is designed to provide a recommendation to an end user, this recommendation would typically be communicated from network module 115 of computer 101 through WAN 102 to EUD 103. In this way, EUD 103 can display, or otherwise present, the recommendation to an end user. In some embodiments, EUD 103 may be a client device, such as thin client, heavy client, mainframe computer, desktop computer, and so on.

REMOTE SERVER 104 is any computer system that serves at least some data and/or functionality to computer 101. Remote server 104 may be controlled and used by the same entity that operates computer 101. Remote server 104 represents the machine(s) that collect and store helpful and useful data for use by other computers, such as computer 101. For example, in a hypothetical case where computer 101 is designed and programmed to provide a recommendation based on historical data, this data may be provided to computer 101 from remote database 130 of remote server 104.

PUBLIC CLOUD 105 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 105 is performed by the computer hardware and/or software of cloud orchestration module 141. The computing resources provided by public cloud 105 are typically implemented by virtual computing environments that run on various computers making up the computers of host physical machine set 142, which is the universe of physical computers in and/or available to public cloud 105. The virtual computing environments (VCEs) typically take the form of virtual machines from virtual machine set 143 and/or containers from container set 144. It is understood that these VCEs may be stored as images and may be transferred among and between the various physical machine hosts, either as images or after instantiation of the VCE. Cloud orchestration module 141 manages the transfer and storage of images, deploys new instantiations of VCEs and manages active instantiations of VCE deployments. Gateway 140 is the collection of computer software, hardware, and firmware that allows public cloud 105 to communicate through WAN 102.

Some further explanations of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

PRIVATE CLOUD 106 is similar to public cloud 105, except that the computing resources are only available for use by a single enterprise. While private cloud 106 is depicted as communicating with WAN 102, in other embodiments, a private cloud may be disconnected from the internet entirely and only accessible through a local/private network. A hybrid cloud is a composition of multiple clouds of different types (for example, private, community, or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 105 and private cloud 106 are both parts of a larger hybrid cloud.

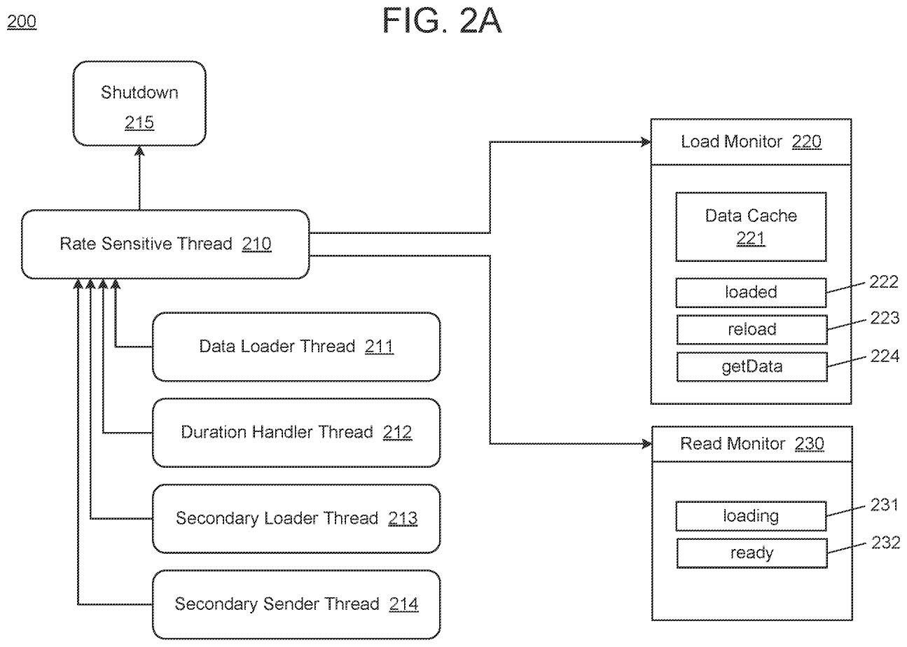

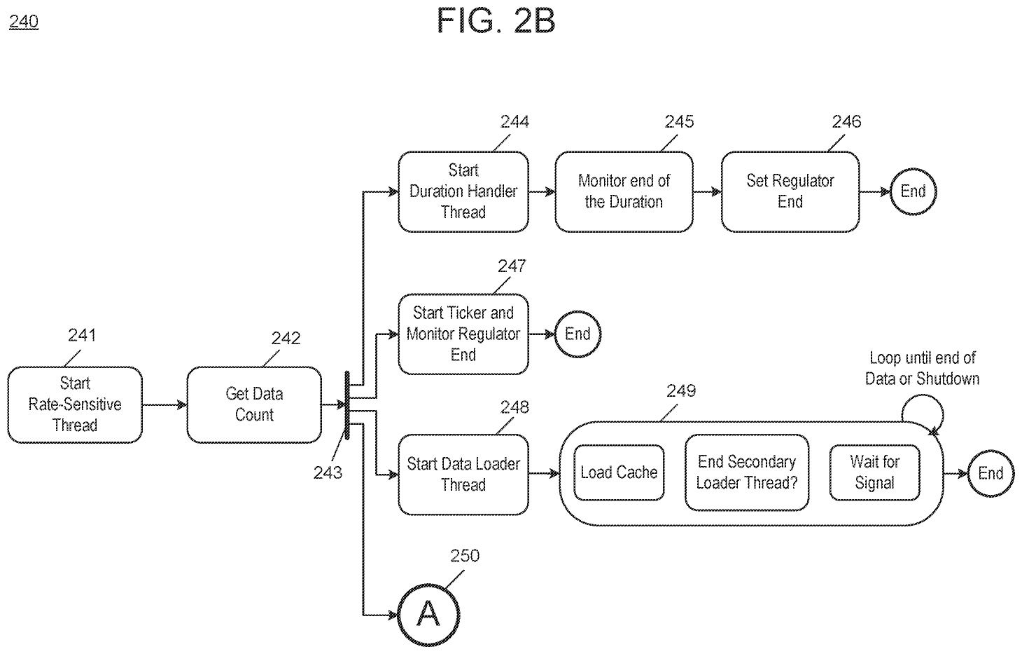

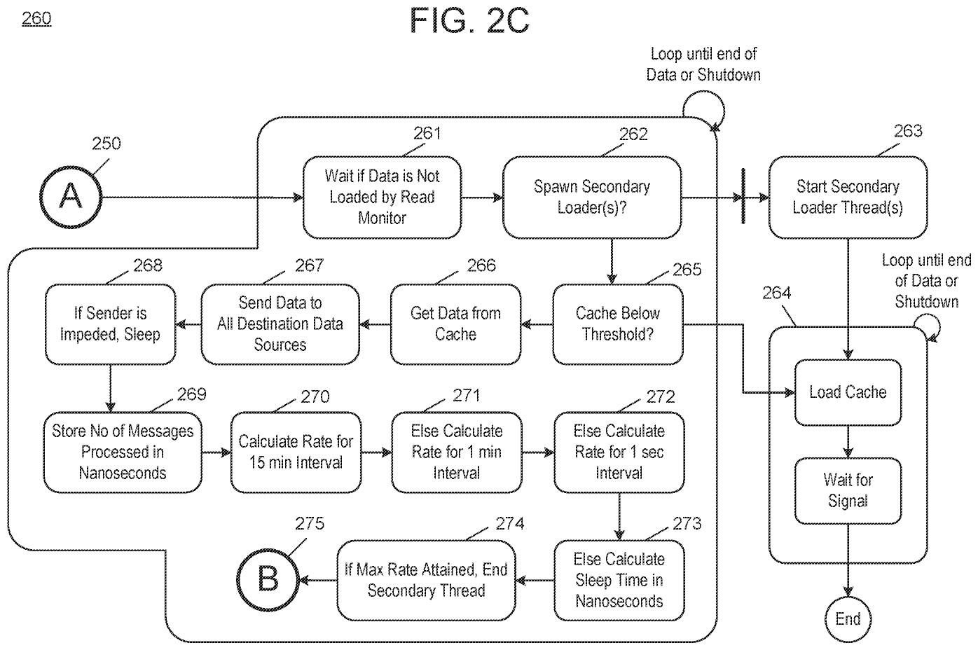

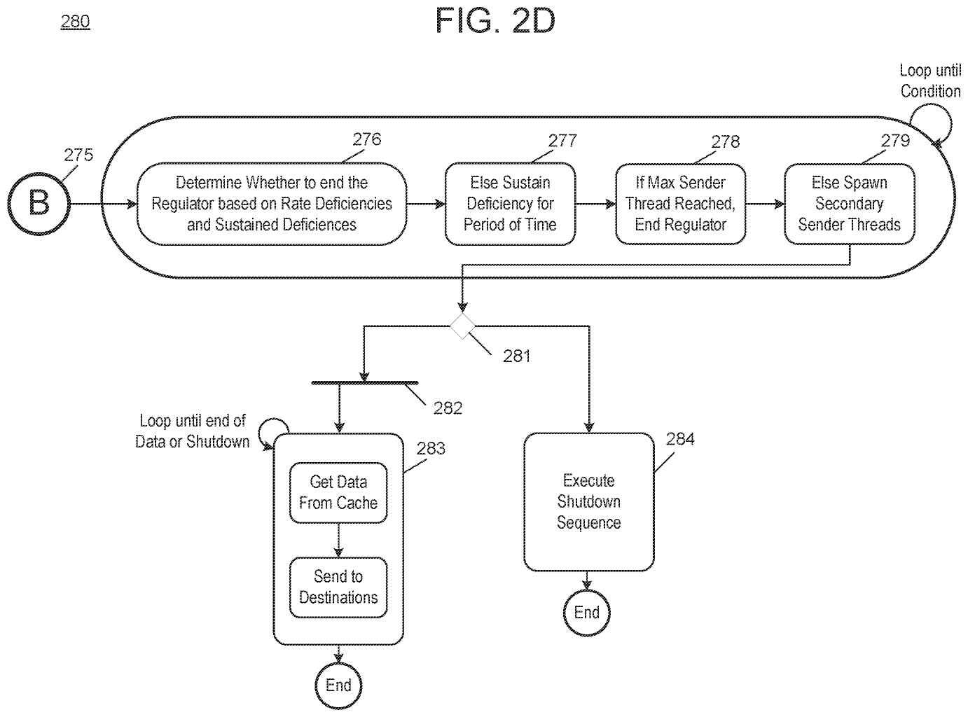

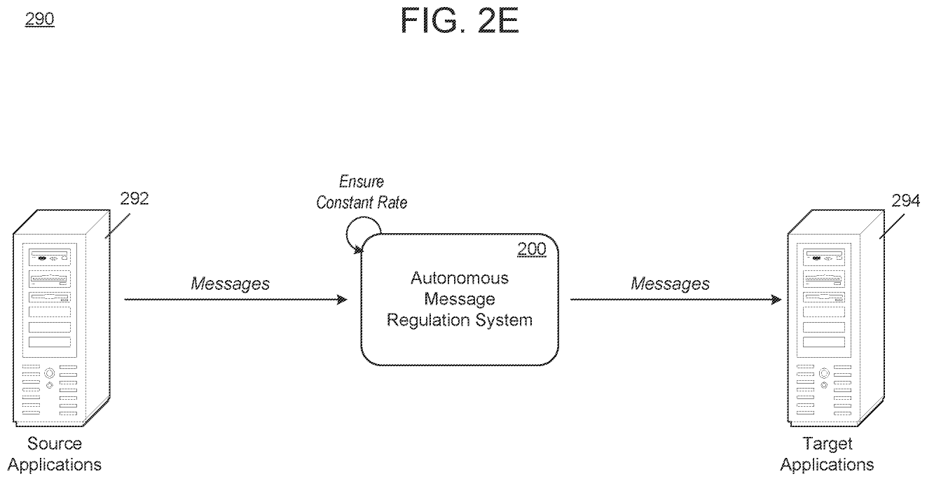

FIG. 2A illustrates a host system for delivering a constant rate of messages to a target system according to example embodiments. Referring to FIG. 2A, the host system is referred to herein as an autonomous message regulation system 200 which can provide a constant rate of messages to a target application. The host system executes/runs a rate sensitive thread 210 that is sending messages from a data store (such as source applications 292 as shown in process 290 or FIG. 2E), to a target application (such as target applications 294 shown in process 290 in FIG. 2E). In one example, the rate sensitive thread 210 may be configured to send messages for a particular period (e.g., one hour) and at a particular constant rate (e.g., 100 messages per second).

The host system also includes a data loader thread 211 configured to load data into a data cache 221, a duration handler thread 212 configured to provide a timing mechanism for the rate sensitive thread 210 and monitor how long the rate sensitive thread has been running. The host system may also include a secondary loader thread 213 that may be spawned to help increase the rate at which messages are loaded into the data cache 221, and a secondary sender thread 214 that may be spawned to help increase the rate at which messages are removed from the data cache 221 and forwarded to the target application.

According to various embodiments, the data loader thread 211 may perform read forwarding and forward messages into the data cache 221. Each of the data loader thread 211, the duration handler thread 212, the secondary loader thread 213, and the secondary sender thread 214 can run in parallel or on-demand. The rate sensitive thread 210 may also trigger a shutdown 215. For example, when the rate sensitive thread 210 has finished processing (e.g., the expected duration has ended, etc.) the rate sensitive thread 210 may terminate or shut down gracefully.

The host system shown in FIG. 2A also includes a load monitor 220 configured to monitor messages loaded into the data cache 221 and determine a rate at which the messages are loaded into the data cache 221, for example, by one or more loading threads. The load monitor 220 may call one or more functions such as a loaded function 222 to indicate that the cache is full and to pause loading until the lower threshold is reached, a reload function 223 to signal that paused loader thread to load data into the cache, a get data function 224 to get data from the cache in a synchronized manner so that one thread has access to specific data from the cache at any point of time, and the like. The host system also includes a send monitor 230 that is configured to monitor and determine a rate at which messages are sent from the data cache 221 to the target application. For example, the send monitor 230 provides functions such as a loading function 231 to pause the sender thread sending data to the target when the cache is empty and is being loaded and a ready function 232 to signal the sender thread to start sending data to the target as soon as there is data in the cache. These functions, especially 224 and 232 are an important part of the regulation process and allow access to the cache in a reliable manner.

When the load monitor 220 detects a decreased rate on data being loaded into the data cache 221 (i.e., if the loading is not keeping up with the constant rate), the load monitor 220 may trigger the secondary loader thread 213 to start. Also, when the send monitor 230 detects a slow down on data being sent from the data cache 221 to the target application, the send monitor 230 may trigger the secondary sender thread 214 to start. The secondary threads can continue running until system performance returns back to normal or until the performance has changed again to a new state that requires modifications in order to maintain the constant rate.

FIGS. 2B-2D are diagrams illustrating processes performed by the host system of FIG. 2A for delivering a constant rate of messages according to example embodiments. For example, FIG. 2B illustrates a process 240 of executing a rate sensitive thread. Referring to FIG. 2B, in 241, the rate sensitive thread is started and the system may deploy and boot-up the rate sensitive thread from storage. In 242, the system may get a data count to determine a number of messages to send, a duration, etc. In 243, the host system starts four different parallel process, for example, including a duration handling thread, a monitoring thread, a loading thread, and a sending thread.

Referring again to FIG. 2B, in 244, a duration handler thread is started to manage the duration of the rate sensitive task. In 245, the duration handler monitors the end of the duration and in 246, the duration handler requests a shutdown to a regulator system. As another example, in 247, the host system may start a ticker, counter, etc., to track/monitor the amount of time that has elapsed enabling the host platform to determine durations with visual indicators that can be displayed. In 248, the host platform may start a data loader which reads forward and loads messages into the cache prior to the messages needing to be sent to the target application. In 249, with the cache loaded, the host system may end one or more secondary loader threads and wait for a shutdown signal. The step of 249 may be repeated iteratively until the end of the duration/data, or until a shutdown signal is received.

Meanwhile, at 250, monitoring and configuring the sending side is further described in the examples of FIGS. 2C and 2D. Furthermore, it should be understood that each of the steps 244, 247, 248, and 250 may be started in parallel and may run in parallel including any trailing steps. That is, these four processes may continually execute until the data is finished being processed or a shutdown signal is received.

Referring now to FIG. 2C, a process 260 of monitoring the loading is performed. Continuing with 250, the process includes waiting for data to be loaded in 261. If enough data is not loaded within a threshold period of time, the host system may determine to start one or more secondary loader threads in 262. Here, the host system may spawn the one or more secondary loader threads in 263 with logic for loading messages into the data cache and continue to monitor the cache to ensure that it stays at or above a predefined fill level/threshold. If it drops below, the system may launch more secondary loader threads. If the rate improves, and the sending side catches up, the system may despawn the secondary loader threads. In 264, the host system continues to monitor the data being loaded and waits for a shutdown signal. If neither occurs, the step 264 continues to loop indefinitely or for a period of time.

After determining whether to spawn secondary loader threads in 262, the host system may determine if the cache is below a fill threshold in 265. If the data in the cache is below the threshold, then it signals the loader thread to start loading the cache. In 266, the system may get messages from the cache and send them to their destinations in 267. In 268, the system can determine if the sender thread is impeded. If so, the loading process can be delayed, paused, or otherwise put to sleep for a period of time. In 269, the host system can identify the number of messages processed on periodic basis (for example, a nanosecond basis) and store such identified number of messages in a storage of the host system.

In 270, the host system may calculate the rate of delivery periodically starting from the largest period (for example, a number of messages sent in 15 minutes to derive the actual rate in that period). It may calculate the rate in a similar manner at the next lower period (for example, 1 minute) in 271, and it may calculate the rate at the next lower period (for example, every second) in 272. The process recommends a certain level of cumulative calculations (for example, at least three) to smooth fluctuations in the data flow. The same or similar process can be executed for any number of calculations and/or time intervals. In 273, the host system can calculate sleep time in a particular period (for example, in nanoseconds). Various calculations involving message timing and system clock settings and characteristics can be utilized with the present system. In 274, the host system can determine whether or not the specified constant rate of messages being sent to the target is achieved. If it has, the host system may terminate the one or more secondary sender threads. The process may then move, via 275, to FIG. 2D.

FIG. 2D illustrates a process 280 of monitoring a sending side of the host system. Referring to FIG. 2D, at 275, the method proceeds to step 276 where the host system may determine whether to end the message regulation process based on rate deficiencies (which may occur when the system cannot send the messages at the rate specified due to limitations of the system and/or network bandwidth) or based on a configuration parameter to sustain the deficient rate. This process can provide details regarding the stability of the target system to process an entire data load and a configurable tolerance value can be set so that the system does not shut down under small or nonpersistent fluctuations in the host system. In 277, the host system may sustain or allow a deficiency for a period of time based on the tolerance value. In 278, if the maximum number of sending threads have been deployed, the system may stop message regulation, else in 279 the host system may spawn one or more secondary sender threads. The maximum number of sender threads is a constant configurable value with a default (if not set for the pool of threads for the sender) or automatically configured based on system conditions.

In 281, the host system determines whether to spawn additional sending threads or execute a shutdown sequence. If in 281 the host system decides to start another secondary sender thread, in 282, the host system can decide whether to get data from the cache. In 283, the host system can get data from the cache and send it to the target application iteratively, until a shutdown signal is received, or the data/duration has ended. As another example, if in 281 the host system decides to execute a shutdown sequence, in 284, the host system can initiate a shutdown sequence to the rate sensitive thread 210 shown in FIG. 2A.

FIG. 2E illustrates a process 290 of autonomously regulating a flow of messages from a source to a target according to example embodiments. Referring to FIG. 2E, one or more source applications from among the source applications 292 may send messages to one or more target applications from among the target applications 294. According to various embodiments, the autonomous message regulation system 200 may ensure a constant rate of delivery of messages/data from the one or more target applications to the one or more source applications using the processes described herein.

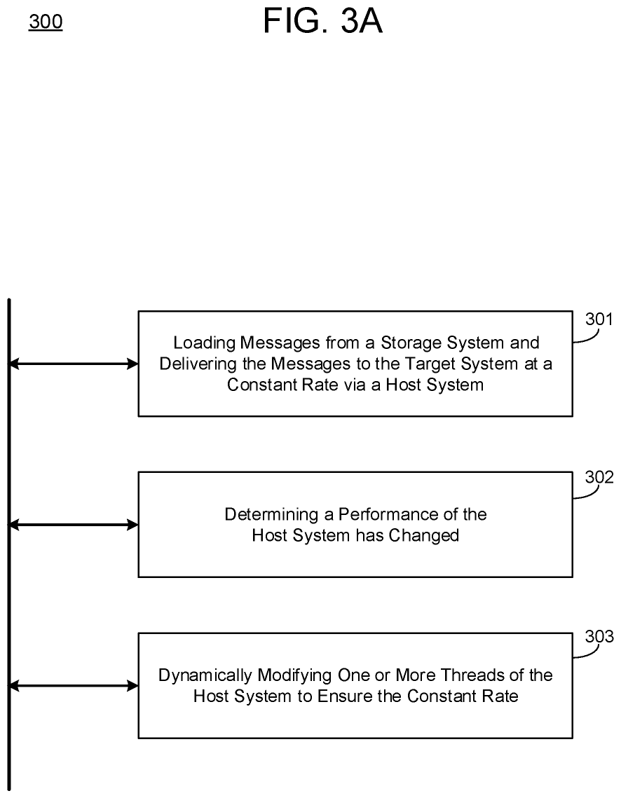

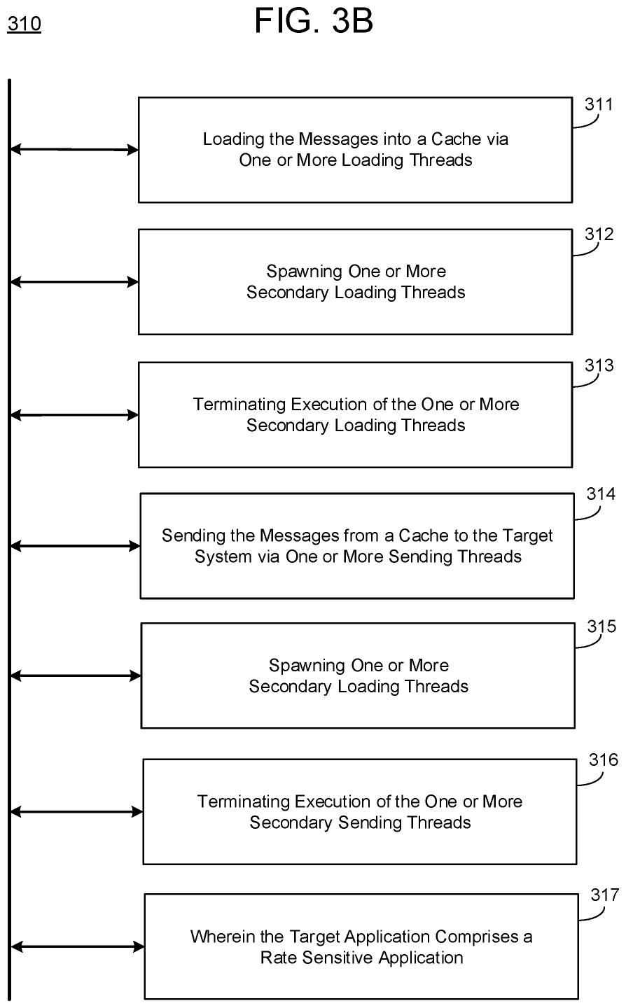

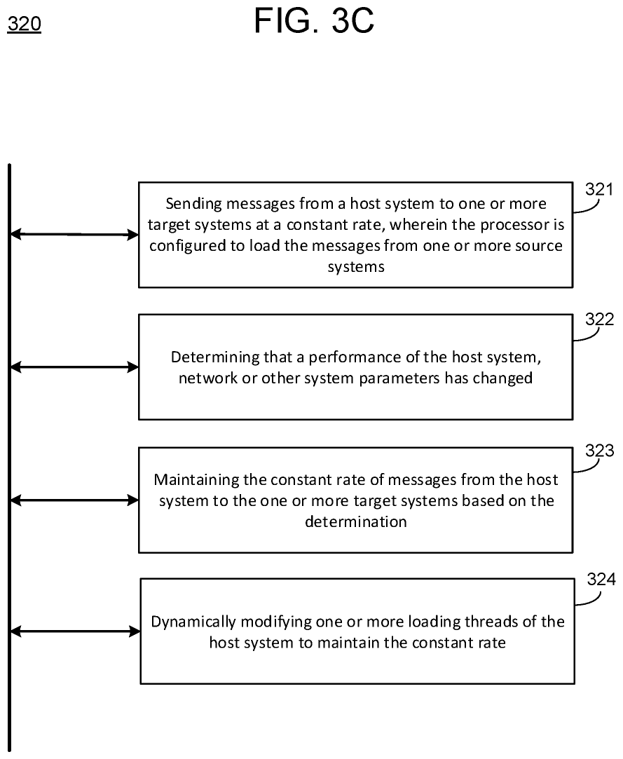

FIG. 3A-C illustrate methods 300, 310 and 320, respectively, of regulating a flow of messages into a target system according to various embodiments.

Referring to FIG. 3A, in 301, the method may include sending messages from a host system to a target system at a constant rate, wherein the sending comprises loading messages from a storage system and sending the messages to the target system via the host system. In 302, the method may include determining that a performance of the host system has changed. In 303, the method may include maintaining the constant rate of messages from the host system to the target system based on the determination, wherein the maintaining comprises dynamically modifying one or more threads of the host system to ensure that the messages sent from the host system to the target system continue to be sent at the constant rate.

Referring now to FIG. 3B, in 311, the method may include loading the messages from the storage system into a cache of the host system via execution of one or more loading threads. In 312, the method may include spawning one or more secondary loading threads for loading additional messages from the storage system into the cache in response to the determination. In 313, the method may include detecting that the performance of the host system has returned to a previous performance, and in response, terminating execution of the one or more secondary loading threads.

In 314, the sending may include sending the messages from a cache of the host system to the target system via execution of one or more sending threads. In 315, the method may further include spawning one or more secondary sending threads for sending additional messages from the cache to the target system in response to the determination. In 316, the method may further include detecting that the performance of the host system has returned to a previous performance, and in response, terminating execution of the one or more secondary sending threads. In 317, the target application may include a rate-sensitive application that depends on a predetermined amount of messages per second.

Referring now to FIG. 3C, in 321, the method may include sending messages from a host system to one or more target systems at a constant rate, wherein the processor is configured to load the messages from one or more source systems, and in 322 determining that a performance of the host system, network or other system parameters has changed. The method continues in 323 with maintaining the constant rate of messages from the host system to the one or more target systems based on the determination, and in 324 with dynamically modifying one or more loading threads of the host system to maintain the constant rate.

The above embodiments may be implemented in hardware, in a computer program executed by a processor, in firmware, or in a combination of the above. A computer program may be embodied on a computer readable medium, such as a storage medium. For example, a computer program may reside in random access memory (“RAM”), flash memory, read-only memory (“ROM”), erasable programmable read-only memory (“EPROM”), electrically erasable programmable read-only memory (“EEPROM”), registers, hard disk, a removable disk, a compact disk read-only memory (“CD-ROM”), or any other form of storage medium known in the art.

Although an exemplary embodiment of at least one of a system, method, and computer readable medium has been illustrated in the accompanying drawings and described in the foregoing detailed description, it will be understood that the application is not limited to the embodiments disclosed but is capable of numerous rearrangements, modifications, and substitutions as set forth and defined by the following claims. For example, the system's capabilities of the various figures can be performed by one or more of the modules or components described herein or in a distributed architecture and may include a transmitter, receiver, or pair of both. For example, all or part of the functionality performed by the individual modules may be performed by one or more of these modules. Further, the functionality described herein may be performed at various times and in relation to various events, internal or external to the modules or components. Also, the information sent between various modules can be sent between the modules via at least one of: a data network, the Internet, a voice network, an Internet Protocol network, a wireless device, a wired device and/or via a plurality of protocols. Also, the messages sent or received by any of the modules may be sent or received directly and/or via one or more of the other modules.

One skilled in the art will appreciate that a “system” could be embodied as a personal computer, a server, a console, a personal digital assistant (PDA), a cell phone, a tablet computing device, a smartphone, or any other suitable computing device, or combination of devices. Presenting the above-described functions as being performed by a “system” is not intended to limit the scope of the present application in any way but is intended to provide one example of many embodiments. Indeed, methods, systems, and apparatuses disclosed herein may be implemented in localized and distributed forms consistent with computing technology.

It should be noted that some of the system features described in this specification have been presented as modules in order to more particularly emphasize their implementation independence. For example, a module may be implemented as a hardware circuit comprising custom very large-scale integration (VLSI) circuits or gate arrays, off-the-shelf semiconductors such as logic chips, transistors, or other discrete components. A module may also be implemented in programmable hardware devices such as field programmable gate arrays, programmable array logic, programmable logic devices, graphics processing units, or the like.

A module may also be at least partially implemented in software for execution by various types of processors. An identified unit of executable code may, for instance, comprise one or more physical or logical blocks of computer instructions that may, for instance, be organized as an object, procedure, or function. Nevertheless, the executables of an identified module need not be physically located together but may comprise disparate instructions stored in different locations which, when joined logically together, comprise the module and achieve the stated purpose for the module. Further, modules may be stored on a computer-readable medium, which may be, for instance, a hard disk drive, flash device, random access memory (RAM), tape, or any other such medium used to store data.

Indeed, a module of executable code could be a single instruction or many instructions and may even be distributed over several different code segments, among different programs, and across several memory devices. Similarly, operational data may be identified and illustrated herein within modules and may be embodied in any suitable form and organized within any suitable type of data structure. The operational data may be collected as a single data set or may be distributed over different locations, including over different storage devices, and may exist, at least partially, merely as electronic signals on a system or network.

It will be readily understood that the components of the application, as generally described and illustrated in the figures herein, may be arranged and designed in a wide variety of different configurations. Thus, the detailed description of the embodiments is not intended to limit the scope of the application as claimed but is merely representative of selected embodiments of the application.

One having ordinary skill in the art will readily understand that the above may be practiced with steps in a different order and/or with hardware elements in configurations that are different from those which are disclosed. Therefore, although the application has been described based upon these preferred embodiments, it would be apparent to those of skill in the art that certain modifications, variations, and alternative constructions would be apparent.

While preferred embodiments of the present application have been described, it is to be understood that the embodiments described are illustrative only, and the scope of the application is to be defined solely by the appended claims when considered with a full range of equivalents and modifications (e.g., protocols, hardware devices, software platforms, etc.) thereto.

What is claimed is:

1. An apparatus comprising:
a processor configured to
send messages from a host system to one or more target systems at a constant rate, wherein the processor is configured to load the messages from one or more source systems,
determine that a performance of the host system, network or other system parameters has changed,
maintain the constant rate of messages from the host system to the one or more target systems based on the determination, and
dynamically modify one or more loading threads of the host system to maintain the constant rate.

2. The apparatus of claim 1, wherein the processor is further configured to load the messages from a storage system into a cache of the host system via execution of the one or more loading threads of the host system.

3. The apparatus of claim 1, wherein the processor is further configured to spawn one or more secondary loading threads to load additional messages from the one or more source systems into a cache of the host system in response to the determination.

4. The apparatus of claim 3, wherein the processor is further configured to detect that the performance of the host system has returned to a previous performance, and in response, terminate execution of the one or more secondary loading threads.

5. The apparatus of claim 1, wherein the processor is further configured to send the messages from a cache of the host system to the one or more target systems via execution of one or more sending threads.

6. The apparatus of claim 1, wherein the processor is further configured to spawn one or more secondary sending threads to send additional messages from a cache of the host system to the one or more target systems in response to the determination.

7. The apparatus of claim 6, wherein the processor is further configured to detect that the performance of the host system has returned to a previous performance, and in response, terminate execution of the one or more secondary sending threads.

8. The apparatus of claim 1, wherein the one or more target systems comprise a rate-sensitive application that depends on a predetermined amount of messages per second.

9. A method comprising:
sending messages from a host system to one or more target systems at a constant rate, wherein the processor is configured to load the messages from one or more source systems,
determining that a performance of the host system, network or other system parameters has changed,
maintaining the constant rate of messages from the host system to the one or more target systems based on the determination, and
dynamically modifying one or more loading threads of the host system to maintain the constant rate.

10. The method of claim 9, wherein the loading comprises loading the messages from the one or more source systems into a cache of the host system via execution of one or more of the loading threads.

11. The method of claim 9, wherein the method further comprises spawning one or more secondary loading threads for loading additional messages from the one or more source systems into a cache of the host system in response to the determination.

12. The method of claim 11, wherein the method further comprises detecting that the performance of the host system has returned to a previous performance, and in response, terminating execution of the one or more secondary loading threads.

13. The method of claim 9, wherein the sending comprises sending the messages from a cache of the host system to the one or more target systems via execution of one or more sending threads.

14. The method of claim 9, wherein the method further comprises spawning one or more secondary sending threads for sending additional messages from a cache of the host system to the one or more target systems in response to the determination.

15. The method of claim 14, wherein the method further comprises detecting that the performance of the host system has returned to a previous performance, and in response, terminating execution of the one or more secondary sending threads.

16. The method of claim 9, wherein the one or more target systems comprise a rate-sensitive application that depends on a predetermined amount of messages per second.

17. A computer-readable storage medium comprising instructions, that when read by a processor, cause the processor to perform:
sending messages from a host system to one or more target systems at a constant rate, wherein the processor is configured to load the messages from one or more source systems,
determining that a performance of the host system, network or other system parameters has changed,
maintaining the constant rate of messages from the host system to the one or more target systems based on the determination, and
dynamically modifying one or more loading threads of the host system to maintain the constant rate.

18. The computer-readable storage medium of claim 17, wherein the loading comprises loading the messages from the one or more source systems into a cache of the host system via execution of one or more of the loading threads.

19. The computer-readable storage medium of claim 17, wherein the instructions further cause the processor to perform spawning one or more secondary loading threads for loading additional messages from the one or more source systems into a cache of the host system in response to the determination.

20. The computer-readable storage medium of claim 19, wherein the instructions further cause the processor to perform detecting that the performance of the host system has returned to a previous performance, and in response, terminating execution of the one or more secondary loading threads.
